(19) United States
(12) Patent Application Publication
(10) Pub. No.: US 2004/0007300 A1
(43) Pub. Date: Jan. 15, 2004

(54) Tire tread with inclined holes

(76) Inventor: Benoit Foucher, Greer, SC (US)

Correspondence Address: Alan A. Csontos, Michelin North America, Inc., P.O. Box 2026, Greenville, SC, 29602, US

(21) Appl. No.: 10/426,774

(22) Filed: Apr. 30, 2003

Related U.S. Application Data
(60) Provisional application No. 60/376,591, filed on Apr. 30, 2002.

(51) Int. Cl. B60C 11/117; B29D 30/52; B29D 30/66; B29C 35/02

(52) U.S. Cl. 152/209.17; 425/28.1; 264/326

(57) ABSTRACT

The present invention is a vehicle tire to support a nominal load, where the tire comprises a tread including apertures inclined with respect to the normal to the surface of the tread at an angle alpha, where alpha is between five degrees and thirty degrees. In one embodiment of the invention, the tread does not include tread blocks. In another embodiment of the invention, the tread only includes wide ribs. In another embodiment of the invention, the tread does not include sipes. In a further embodiment of the invention, the tread comprises styrene-butadiene rubber in a further embodiment of the invention, the apertures are in echelon formation. In one embodiment of the invention, each aperture is an ellipse.

### FIELD OF THE INVENTION

This invention relates to vehicle tires, and more particularly to heavy-duty truck tires specifically designed for long haul trucking operations.

Irregular tire wear includes namely full shoulder wear, feather wear, shoulder cupping, rib depression, flat spotting wear, erratic depression wear, rail wear and more. A complete explanation of all types of irregular tire wear can be found in a guide entitled “Radial Tire Conditions Analysis Guide: A Comprehensive Review of Tread Wear and Conditions”, published by The Truck Maintenance Council (TMC).

There are many factors that can lead to premature tire wear. The conditions the truck is running in as well as the type of load the truck is carrying both have an impact on tire wear. This invention concerns mainly tires used in long haul applications. In these applications, the majority of the time the tire is going to be running in a straight line, where there is very little torque, if any, applied to the front axle tires. This is opposite to regional applications, e.g., with pick up and delivery vehicles, which run with a lot of turning and twisting, a lot of starts and stops. Normal stresses become as important as the longitudinal and lateral stresses in producing irregular tire wear. Whatever amount of irregular wear started on the tire in regional operations, this irregular wear is erased because of all the scrubbing and sideways movement of the tires in the regional application; which causes a rather high rate of wear. Abnormal wear is much less of an issue in regional operations simply because the dominant wear process is global scrubbing over the contact area of the tire tread.

Truck tires that experience straight ahead driving for a large portion of their lives develop wear patterns that are unique. Tire stresses from turning and maneuvering the vehicle only exist for a limited time compared with tire stresses from straight-ahead highway driving. The leading cause of irregular or premature tire wear is improper inflation pressure, with alignment coming in a close second. Poor alignment of the wheels is a common cause of irregular wear as well as compliance of the truck's suspension and steering linkages. Poor alignment includes improper drive axle thrust angle, elasticity in the steering system, and drive axle lateral offset. Some of these factors are under the control of the owner and can be minimized with good maintenance practices. Others are inherently present within the steering and suspension system designs for state-of-the-art trucks.

In long haul application, irregular or uneven wear remains an issue because the tires, as they are improved in endurance, are able to last for an extremely high number of miles at a very slow rate of wear. Therefore, the chance that uneven or irregular wear governs the tread life of the tire increases. There are many different factors that can cause irregular tire wear, and it is most often a combination of them that starts uneven wear or causes it to increase. The combination is what makes it difficult for designers to find the right causes for an uneven wear problem. Long haul steer axle truck tires commonly have a tread pattern with a series of circumferential ribs separated by circumferential grooves. Irregular wear of rib type tires frequently starts at the edges of these ribs causing depressions, flat spots and the like, which progress across the rib and along the rib with increased mileage. This is commonly called railway wear. By controlling the onset of this irregular wear pattern the user can increase the useful tread life of the tire's tread.

Although many factors seem to be closely related to maintenance parameters, the prior art already knows many attempts to try to improve the intrinsic ability of the tire to sustain long haul operations without developing uneven wear. Reference can be made to U.S. Pat. No 4,840,210 that discloses an attempt to keep under control the shape of a shoulder area of a tire's tread in an effort to limit the onset of irregular changes in the tread as the tire wears. The solution proposed in the reference requires mounting the tire on the rim on a preselected way because of the asymmetrical profile. In U.S. Pat. No. 5,099,899 the railway wear is suppressed by increasing the zigzag angle of the main circumferential grooves as the tread wears out. Yet another means to control irregular wear at the shoulders is disclosed in U.S. Pat. No. 4,214,618. A circumferentially extending narrow zigzag groove at the edge of the shoulder contact surfaces reduces the railway wear and growth thereof toward the center of the tread.

A need remains to reduce the stresses on the main ribs of the steer axle truck tire during straight-ahead driving. Although the prior art already knows several tires that have proved to work satisfactorily in the above mentioned long haul operations, a need exists to further improve the way the contact area of long haul truck tires can best comply with the supporting surface when subjected to wearing stresses. This improvement is best accomplished by a tread pattern that is designed to delay the onset of irregular wear for the long haul truck tire.

Accordingly, an object of the present invention is to reduce the onset of irregular wear of steer axle and trailer truck tires and reduce the growth thereof during long haul operations.

### SUMMARY OF THE INVENTION

The present invention is a vehicle tire to support a nominal load, where the tire comprises a tread including apertures inclined with respect to the normal to the surface of the tread at an angle alpha, where alpha is between approximately five degrees and thirty degrees. In one embodiment of the invention, the tread does not include tread blocks. In another embodiment of the invention, the tread only includes wide ribs. In another embodiment of the invention, the tread does not include sipes. In a further embodiment of the invention, the tread comprises styrene-butadiene rubber. In a further embodiment of the invention, the apertures are in echelon formation. In one embodiment of the invention, each aperture is an ellipse.

### BRIEF DESCRIPTION OF THE FIGURES

FIG. 1 is a diagram of a tire showing apertures in the tread.

FIG. 2 is an illustration of the measurement of height and width of tread ribs (not to scale).

FIG. 3 is an illustration of a segment of a tire mold.

FIG. 4 shows a section of tread with elliptical apertures in echelon formation, with a spacing of five millimeters between the center of each aperture, and where each aperture has a major axis of 1.2 mm, and a minor axis of 1.2 mm.

### DETAILED DESCRIPTION OF THE INVENTION

The present invention is a vehicle tire to support a nominal load, where the tire comprises a tread including apertures inclined with respect to the normal to the surface of the tread at an angle alpha, where alpha is between approximately five degrees and thirty degrees. In another embodiment of the invention, the angle alpha is between approximately ten and twenty degrees. In a further embodiment of the invention, alpha is between twelve and seventeen degrees. In another embodiment of the invention, the angle alpha is approximately fifteen degrees. In a further embodiment of the invention, alpha is selected from the group consisting of approximately ten, eleven, twelve, thirteen, fourteen, fifteen, sixteen, seventeen, eighteen, nineteen, and twenty degrees. In one embodiment of the invention, the tread does not include tread blocks. In another embodiment of the invention, the tread only includes wide ribs. As used herein, “wide rib” means a rib whose width to height ratio is greater than 2.5, where the height of a rib is defined as the height of its largest wall (as measured from the bottom of the adjacent groove when the tire is mounted on its rim at normal operating pressure), and the width is measured at the top of the groove. FIG. 2 provides an illustration. In one embodiment of the invention, the width to height ratio of the rib is greater than 2.5. In another embodiment of the invention, the width to height ratio of the ribs is greater than 3. In another embodiment of the invention, the width to height ratio is greater than 4 (in otherwords, the rib is more than four times as wide as it is high).

It is intended that the apertures be uniformly distributed along the tread of the tire, that is to say, the outer circumference of the tire contacting the ground (excluding the grooves).

In another embodiment of the invention, the tread does not include sipes. In a further embodiment of the invention, the tread comprises styrene-butadiene rubber. In a further embodiment of the invention, the apertures are in echelon formation. In one embodiment of the invention, each aperture is an ellipse. That is to say, the intersection of a plane at right angles to the long axis of an aperture and the aperture would form an ellipse.

In one embodiment of the invention, the tire is intended to be mounted on a non-driving axle of a truck. In another embodiment of the invention, the tire comprises three or four circumferential ribs, with either two or three grooves, respectively, between the ribs. The tire may comprise more than four circumferential ribs.

In one embodiment of the invention, the center. of each aperture is between approximately 3 millimeters and fifteen millimeters distant from the center of any other aperture. In another embodiment of the invention, that distance is approximately five to six millimeters. In another embodiment, the apertures are elliptical. In one embodiment of the invention, each axis of the ellipse is between approximately one and three millimeters. In one embodiment, the ellipse has a major axis of approximately 2 millimeters, and a minor axis of approximately 1.3 millimeters. In another embodiment of the invention, the area of each aperture is between 1 millimeter squared and three millimeters squared.

In one embodiment of the invention, the aperture is as deep as the tread. In another embodiment of the invention, the aperture is between approximately one-half tread depth and full tread depth.

The invention includes both pneumatic and non-pneumatic tires, as well as bias-ply and radial non-pneumatic tires. In one embodiment of the invention, the tread does not include tread blocks.

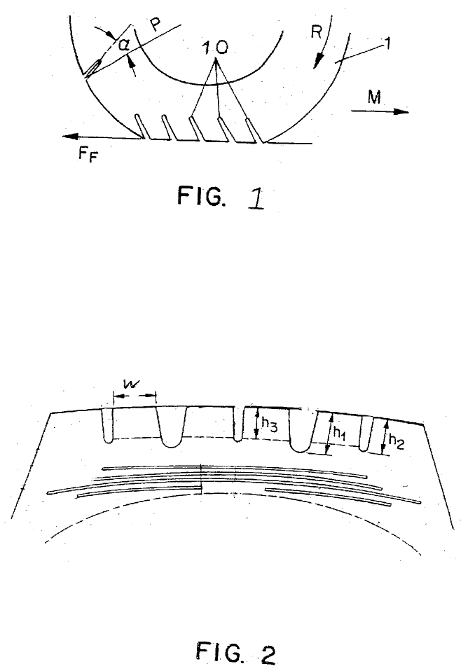

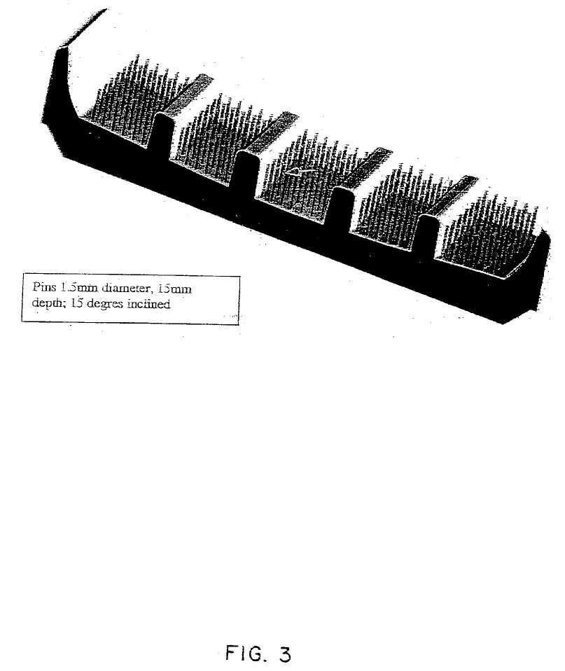

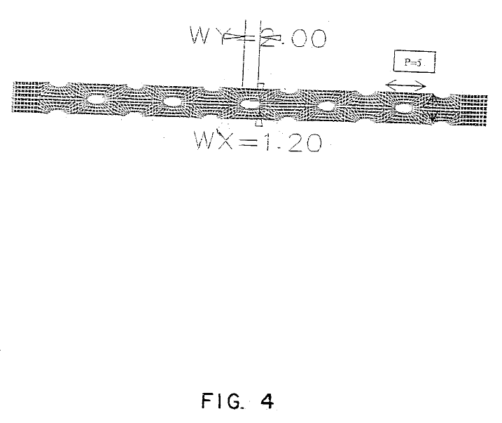

FIG. 1 is a diagram of a tire 1 according to the invention. Apertures 10 are inclined at angle alpha to the normal P to the surface of the tread. M designates the direction of forward travel of the vehicle, and F is the resultant force exerted by the ground on the tread in the contact ellipse. In FIG. 1 the apertures are all inclined with respect to a direction perpendicular to the tread in a direction of inclination which is opposite to the prescribed forward direction of rotation of the tire, indicated by arrow R. The apertures may be in staggered echelon formation. In one embodiment of the invention, the lack of tread blocks, the lack of narrow ribs, or the lack of sipes, permits the use of styrene-butadiene rubber as the tread compound or as the tire compound. The lack of tread blocks, narrow grooves, or sipes reduces chafing and chipping of a styrene-butadiene rubber tread.

The invention may be further understood with reference to the following non-limiting example.

### Example 1

Tires were constructed according to the invention. The dimensions were MZA3 275/80r22.5 or XZA2 275/80r22.5. The tread depth was 19/32″. It was designed for a 2600 kg load and 7.9 bars inflation pressure. The geometry of the tread was 15 mm thick and 62 mm wide. Each aperture was an ellipse with major axis 2 mm and minor axis 1.3 mm, and depth of 15 mm. The holes had a pace of 5 mm, for about 20,000 holes around the tire.

The following was the expected performance:

| | | Comments |
|---|---|---|
| Mass | −1.5 kg | Narrow shoulder ribs removed |
| Rolling resistance | Greater or equal | 3 wide ribs - better |
| | (wide ribs better, compressibility | holes compression stiffness: |
| | with holes worse, but combined | positive (as compared to 3 rib tire |
| | is the same or better) | without holes) |
| | | overall same energy dissipation |
| | | as a 5 ribs tire (drag force same or |
| | | better) |
| Wear | Greater than 10% better wear | 3 solid ribs: positive |
| | (wider ribs positive, lower | shear stiffness: decreases |
| | stiffness with holes, CSR | CSR (percent of area of contact |
| | increased, combined is better) | patch that is not void): negative |
| Adherence wet | Better | High edges density in X and Y |
| | | direction |
| Tread durability | Better | Should allow the use of styrene- |
| | | butadiene rubber tread |
| Process: curing | Better | Positive impact: holes and less |
| | | rubber in the shoulder area |

Variations and modifications of the invention will be apparent to those of skill in the art after reviewing the present specification and drawings. These variations and modifications are meant to fall within the scope of the appended claims.

I claim:

1. A vehicle tire for support of a nominal load, wherein the tire comprises a tread, and wherein the tread comprises apertures at an angle alpha formed by the radius of the tire intersecting the long axis of the aperture at the outer surface of the tread at a point “a”, wherein the radius and the long axis of the aperture and the vector whose endpoint is at point “a” and which points in the direction of forward rolling of the tire all lie in the same plane;
wherein the angle alpha is between approximately 5 and 30 degrees.

2. The tire of claim 1, wherein alpha is between approximately 10 and 20 degrees.

3. The tire of claim 1, wherein alpha is between approximately 12 and 17 degrees.

4. The tire of claim 1, wherein the tire is a pneumatic tire.

5. The tire of claim 1, further comprising wherein the tire is mounted on a non-driving axle of a vehicle.

6. The tire of claim 1 wherein the apertures are located within the ribs.

7. The tire of claim 1, further comprising three or four circumferential ribs, wherein the apertures are located within the ribs.

8. A method of designing a tire including apertures in the tread, wherein the volume of a groove is replaced by an equivalent volume of apertures.

9. The tire ot claim 1, wherein the tread does not include tread blocks.

10. The tire of claim 1, wherein the apertures' shape is an ellipse.

11. The tire of claim 1, further comprising wherein each aperture has an opening approximately between one millimeter squared and three millimeters squared in area.

12. The tire of claim 10, wherein each axis of the ellipse is between approximately one and three millimeters long.

13. The tire of claim 10, wherein the ellipse has a major axis of approximately 2 millimeters, a minor axis of approximately 1.3 millimeters.

14. The tire of claim 1, wherein the long axis defining the center of each aperture is between approximately three to fifteen millimeters distant from the center of another aperture.

15. The tire of claim 1, wherein the long axis defining the center of each aperture is between. approximately five to six millimeters distant from the center of another aperture.

16. The tire of claim 1, wherein the tire is selected from the group consisting of bias-ply tires and radial tires.

17. The tire of claim 1, wherein the apertures are in echelon formation.

18. The tire of claim 1, wherein the tire comprises styrene-butadiene rubber.

19. The tire of claim 1, further comprising wherein the tread has no tread blocks.

20. The tire of claim 1, further comprising wherein the tread has no sipes.

21. The tire of claim 1, further comprising wherein the tread includes only wide ribs.

22. The tire of claim 21, further comprising wherein the width to height ratio of the ribs is more than about 2.5.

23. The tire of claim 21, further comprising wherein the width to height ratio of the ribs is greater than 3.

24. The tire of claim 21, further comprising wherein the width to height ratio of the ribs is greater than 4.

25. The tire of claim 1, where alpha is selected from the group consisting of approximately 10, 11, 12, 13, 14, 15, 16, 17, 18, 19, and 20 degrees.

26. The tire of claim 25, wherein alpha is approximately 15 degrees.

27. A vehicle tire to support a nominal load, wherein the tire comprises a tread including apertures inclined with respect to the normal to the surface of the tread at an angle alpha, where alpha is between five degrees and thirty degrees.

28. A tire mold for making the tire of claim 1.
